(19) United States
(12) Patent Application Publication
(10) Pub. No.: US 2017/0011421 A1
(43) Pub. Date: Jan. 12, 2017

(54) PREFERENCE ANALYZING SYSTEM

(71) Applicant: HITACHI, LTD., Tokyo (JP)

(72) Inventors: Marina FUJITA, Tokyo (JP); Toshiko AIZONO, Tokyo (JP); Koji ARA, Tokyo (JP)

(21) Appl. No.: 15/121,166

(22) PCT Filed: Jul. 29, 2014
(86) PCT No.: PCT/JP2014/069874

§ 371 Date: Aug. 24, 2016

(51) Int. Cl. G06Q 30/02

(52) U.S. Cl. CPC G06Q 30/0255; G06Q 30/0269

(57) ABSTRACT

The present invention aims to extract change factors that raise and lower evaluation with respect to a product based on a purchase history of an individual. A preference analyzing system according to the present invention learns, from a purchase history, a preference model that evaluates purchase preference of an individual, calculates correlation between a feature quantity representing an attribute of a product and a mixed attribute that can raise and lower evaluation of the product, and extracts other product attributes that change the mixed attribute (see FIG. 6).

### TECHNICAL FIELD

The present invention relates to a technique that analyzes purchase preference of an individual.

### BACKGROUND ART

To prevent customers from being bored, many stores have frequently changed combinations of products displayed therein by introducing new products. To respond to such style of selling, it is important to predict the volume of sales in consideration of products that are not frequently sold and the influence of competition between a plurality of products. Accordingly, desired is a technique that can precisely perform selling prediction of various products in consideration of the influence of competition between a plurality of products.

Japanese Patent Application No. 2013-170189 describes a technique that performs the above selling prediction. Patent Literature 1 below describes a recommend technique that provides a customer with information to arouse eagerness for the purchase of a product.

### CITATION LIST

### Patent Literature

Patent Literature 1: Japanese Unexamined Patent Publication (Kokai) No, 2002-334257

### SUMMARY OF INVENTION

### Technical Problem

Whether a customer purchases a product, that is, evaluation by the customer with respect to the product, is influenced by an attribute of the product. Its evaluation tendency is not always fixed, and can be raised or lowered according to other conditions. For example, there can be a mixed evaluation tendency in which a customer actively purchases a product having both of a first attribute and a second attribute and in which the customer does not purchase a product having both of the first attribute and a third attribute.

Both of Japanese Patent Application No. 2013-170189 and Patent Literature 1 do not describe about identifying change factors that raise and lower the evaluation tendency when a pattern raising evaluation of a product and a pattern lowering evaluation of the same product coexist, such as described above.

The present invention has been made in view of the above problems, and an object of the present invention is to extract change factors that raises and lowers evaluation of a product based on a purchase history of an individual.

### Solution to Problem

A preference analyzing system according to the present invention learns, from a purchase history, a preference model that evaluates purchase preference of an individual, calculates correlation between a feature quantity representing an attribute of a product and a mixed attribute that can both raise and lower evaluation of the product, thereby extracting other product attributes that change the mixed attribute.

### Advantageous Effects of Invention

In the preference analyzing system according to the present invention, when there is a mixed evaluation pattern capable of both raising and lowering evaluation of a product by an individual, change factors thereof can be extracted based on a purchase history of the individual.

### BRIEF DESCRIPTION OF DRAWINGS

FIG. 1 is a block diagram of a preference analyzing system 1000 according to a first embodiment.

FIG. 2 is a function block diagram of a center server 100.

FIG. 3 is a concept view illustrating an example of preference tree data 105.

FIG. 4 is a concept view of assistance in explaining a process of an evaluation tendency classifier 106.

FIG. 5 is a concept view of assistance in explaining a process of a feature quantity analyzer 108.

FIG. 6 is a concept view of assistance in explaining a process of a change factor extractor 110.

FIG. 7 illustrates an operation flow of the center server 100.

FIG. 8 is a flowchart of assistance in explaining the detail of step S701.

FIG. 9 is a flowchart of assistance in explaining the detail of step S702.

FIG. 10 is a flowchart of assistance in explaining the detail of step S703.

FIG. 11 is a flowchart of assistance in explaining the detail of step S704.

FIG. 12 is a function block diagram of a store server 200 according to a second embodiment.

FIG. 13A illustrates a totalizing result example of a totalizer 210 and its screen display example.

FIG. 13B illustrates another example of a totalizing result by the totalizer 210 associated with the same analyzing result as FIG. 13A and its screen display.

FIG. 13C illustrates a display example of another preference model learning result.

FIG. 13D illustrates another example of a totalizing result by the totalizer 210 associated with the same analyzing result as FIG. 13C and its screen display.

FIG. 14A illustrates another example of a totalizing result by the totalizer 210 and its screen display.

FIG. 14B illustrates another example of a totalizing result by the totalizer 210 and its screen display.

FIG. 15A illustrates another example of a totalizing result by the totalizer 210 and its screen display.

FIG. 15B illustrates another example of a totalizing result by the totalizer 210 and its screen display.

FIG. 16 is a function block diagram of the store server 200 according to a third embodiment.

FIG. 17 illustrate processing result examples of a recommender 230 and their screen display examples.

FIG. 18A illustrates another example of a processing result by the recommender 230 and its screen display.

FIG. 18B is a table illustrating a structure of a data table holding an analyzing result by the recommender 230 and a data example.

FIG. 19 is an example of a selling promotion message transmitted by the recommender 230.

FIG. 20 is a hardware configuration example of the center server 100.

### DESCRIPTION OF EMBODIMENTS

### First Embodiment

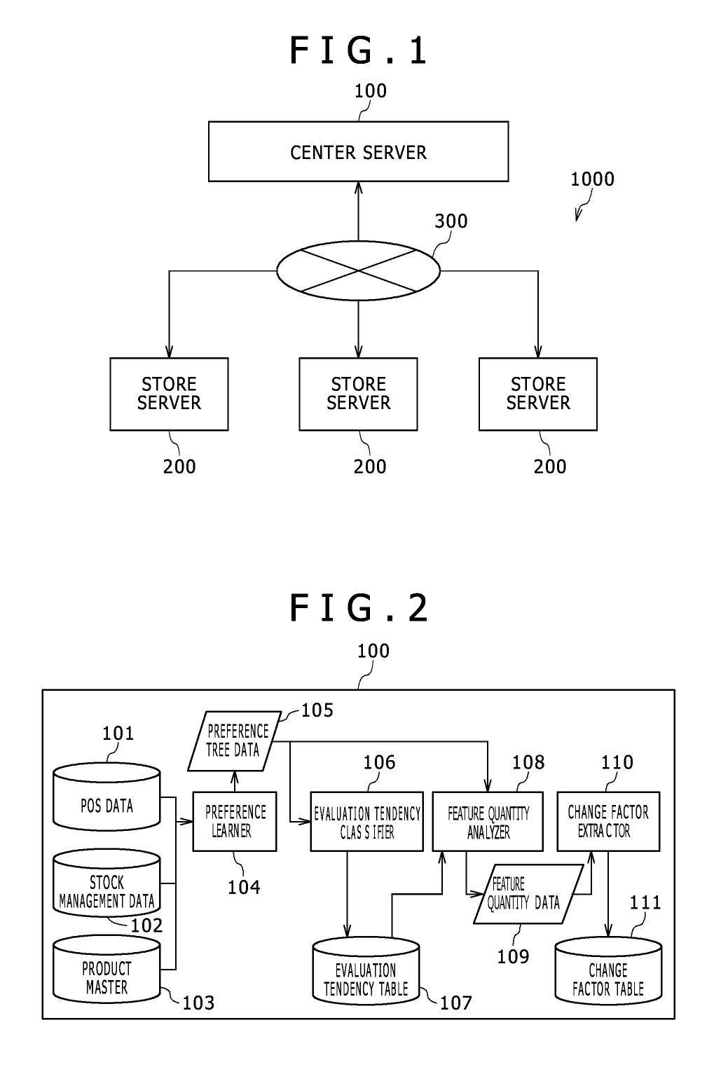

FIG. 1 is a block diagram of a preference analyzing system 1000 according to a first embodiment of the present invention. The preference analyzing system 1000 is a system that analyzes purchase preference of an individual, and includes a center server 100 and at least one store server 200, which are connected by a network 300.

The center server 100 is a server computer that analyzes purchase preference of each individual, and includes a configuration described later with reference to FIG. 2. The store server 200 totalizes analyzing results of customers in the store by the center server 100, and provides data for making use of the analyzing results in business of the store.

FIG. 2 is a function block diagram of the center server 100. The center server 100 includes POS data 101, stock management data 102, a product master 103, a preference learner 104, an evaluation tendency classifier 106, a feature quantity analyzer 108, and a change factor extractor 110.

The POS data 101 is purchase history data that describes a history in which each individual purchases a product. The stock management data 102 is data that describes a stock management state of the product. The product master 103 is master data that describes an item and an attribute of the product. The attribute means a characteristic that influences product purchase of a consumer, and is e.g., information on price, product ingredient, and design. As the attribute, a design concept may be given such as conservative design. Not only the characteristic of the product itself, but also a characteristic of an environment in which the product is purchased, may also be given. This includes e.g. bargain sale or non-bargain sale information, and purchase time information (morning/afternoon/night, and holiday/weekday). These data pieces can be obtained from e.g., an appropriate data source outside the center server 100, but the obtaining method thereof is not limited to this.

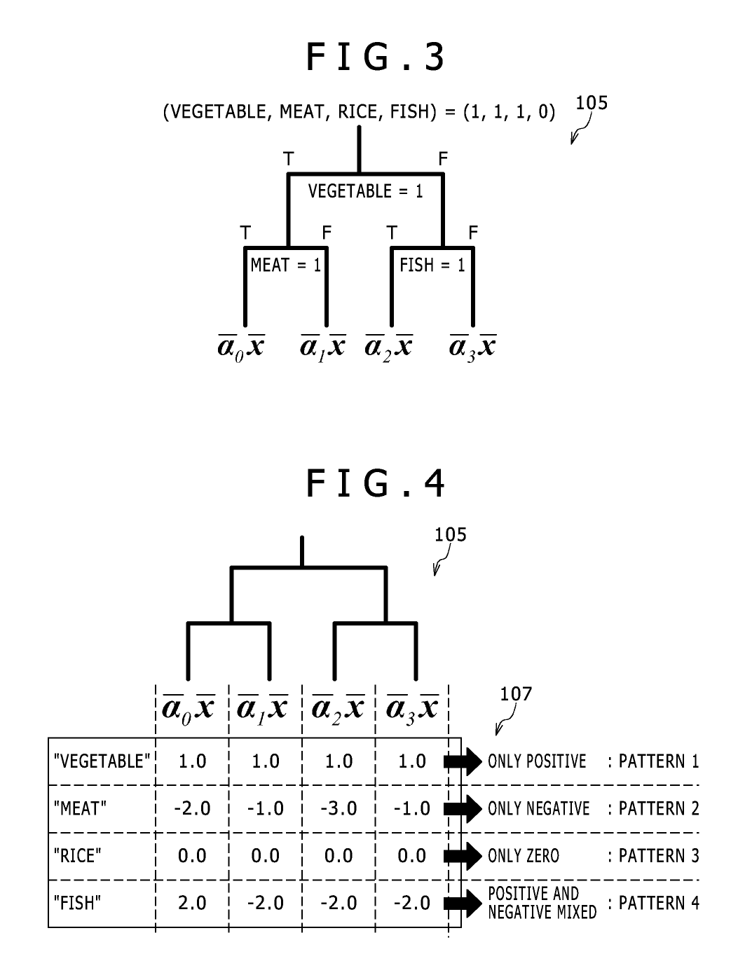

The preference learner 104 uses the POS data 101, the stock management data 102, and the product master 103 to learn purchase preference of each individual, and outputs its learning result as preference tree data 105. Examples of a learning process of the preference learner 104 and the preference tree data 105 are described in detail in Japanese Patent Application No. 2013-170189. The preference learner 104 can generate the preference tree data 105 by using the method described in the literature. A concept of the preference tree data 105 will be supplemented later with reference to FIG. 3.

The evaluation tendency classifier 106 classifies a tendency as to how an individual evaluates an attribute of a product based on an evaluation value raising/lowering pattern. The evaluation tendency classifier 106 outputs its classification result as an evaluation tendency table 107. A specific operation of the evaluation tendency classifier 106 will be described later.

Assume that there are four attributes of a product “packed lunch”: “vegetable”, “meat”, “rice”, and “fish”. The following example can be considered as raising/lowering patterns of evaluation tendencies classified by the evaluation tendency classifier 106.

### (Evaluation Tendency Raising/Lowering Pattern 1: Always Like)

When an individual always shows positive purchase preference with respect to packed lunch having the attribute “vegetable”, it is considered that the possibility that the individual purchases the packed lunch having the attribute “vegetable” is high. Thus, it is considered that the attribute “vegetable” has an evaluation tendency pattern that always raises evaluation of the packed lunch.

### (Evaluation Tendency Raising/Lowering Pattern 2: Always Dislike)

When an individual always shows negative purchase preference with respect to packed lunch having the attribute “meat”, it is considered that the possibility that the individual purchases the packed lunch having the attribute “meat” is low. Thus, it is considered that the attribute “meat” has an evaluation tendency pattern that always lowers evaluation of the packed lunch.

### (Evaluation Tendency Raising/Lowering Pattern 3: Not Concerned)

When an individual shows no purchase preference with respect to the attribute “rice”, it is considered that the possibility that the individual purchases packed lunch having the attribute “rice” cannot be evaluated. Thus, it is considered that the attribute “rice” has an evaluation tendency pattern that does not influence (or that hardly influences) evaluation of the packed lunch.

### (Evaluation Tendency Raising/Lowering Pattern 4: Like or Dislike According to Condition)

When mixed are a case where an individual shows positive purchase preference with respect to the attribute “fish” and a case where the individual shows negative purchase preference with respect to the attribute “fish”, it is considered that the possibility that the individual purchases packed lunch having the attribute “fish” depends on other attributes. Thus, it is considered that the attribute “fish” has an evaluation tendency pattern that raises and lowers evaluation of the packed lunch according to other attributes. It is considered that the attribute representing such a mixed pattern (here, “fish”) can increase the possibility that the individual purchases packed lunch having both of the attribute “fish” and other attributes changing to positive purchase preference. Then, the center server 100 extracts other attributes that raise evaluation of the packed lunch having the attribute “fish”, as a positive change factor with respect to the attribute “fish”. Likewise, the center server 100 can extract other attributes that lower evaluation of the packed lunch having the attribute “fish”, as a negative change factor with respect to the attribute “fish”.

The feature quantity analyzer 108 analyzes a feature quantity of a product classified into each leaf node (end node) of the preference tree data 105, and outputs it as feature quantity data 109. The feature quantity data 109 can describe a vector having, as an element value, a numerical value representing easiness by which a product attribute of a product classified into a leaf node becomes a particular value. A specific example of the feature quantity data 109 will be described later.

The change factor extractor 110 calculates correlation between an evaluation tendency of an attribute representing the mixed pattern and a feature quantity vector described by the feature quantity data 109, thereby identifying other attributes that positively changes evaluation of a product having the attribute representing the mixed pattern. Its specific method will be described later. The change factor extractor 110 outputs the identification result as a change factor table 111.

FIG. 3 is a concept view illustrating an example of the preference tree data 105. Here, shown is an example in which there are four attributes of a product “packed lunch”: “vegetable”, “meat”, “rice”, and “fish”. A characteristic of the packed lunch can be described by a vector representing whether the characteristic of the packed lunch has each attribute. For example, the characteristic of the packed lunch that uses ingredients “vegetable”, “meat”, and “rice”, but that does not use “fish” can be represented as (1,1,1,0).

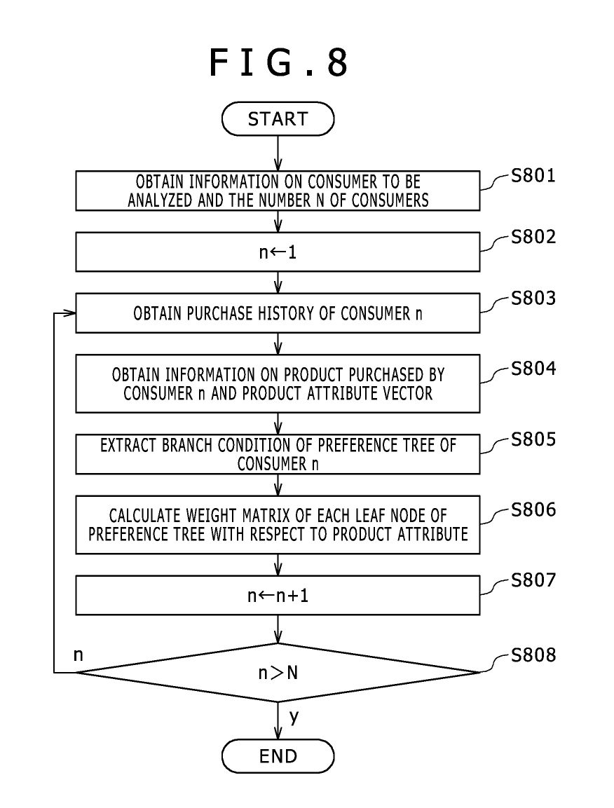

To each leaf node of the preference tree data 105, an evaluation function is allocated. The preference tree data 105 is a kind of a decision tree that decides any one of evaluation functions to evaluate an attribute of packed lunch. For example, in the example illustrated in FIG. 3, packed lunch having the attributes “vegetable” and “meat” is evaluated by evaluation function a0x, and packed lunch not having the attribute “vegetable” but having the attribute “fish” is evaluated by evaluation function a2x. The preference learner 104 learns, as teacher data, a purchase history of an individual described by the POS data 101, and learns any one of the evaluation functions to evaluate packed lunch. Further, the preference learner 104 also learns a coefficient in each evaluation function. Its specific method is described in detail in Japanese Patent Application No. 2013-170189, and its overview will be described later with reference to FIG. 8.

FIG. 4 is a concept view of assistance in explaining a process of the evaluation tendency classifier 106. The evaluation tendency classifier 106 extracts a coefficient of an evaluation function corresponding to each leaf node of the preference tree data 105, by which each attribute is multiplied. For example, assume that evaluation function a0x=1.0×(vegetable)−2.0×(meat)+0.0×(rice)+2.0×(fish), coefficients of evaluation function a0x are illustrated in the left end column in FIG. 4. Likewise, a coefficient of the other evaluation function, by which each attribute is multiplied, is extracted. Such a coefficient itself is not necessarily used as-is, and may be subjected to an appropriate process (e.g., normalization).

The evaluation tendency classifier 106 aligns coefficients of extracted evaluation functions with respect to the same attribute. For example, coefficients of evaluation functions a0x to a3x, by which the attribute “vegetable” is multiplied, are “1.0”, “1.0”, “1.0”, and “1.0” aligned in the first row in FIG. 4. That is, the coefficients, by which the attribute “vegetable” is multiplied, are all positive values. In this case, it can be said that the individual always shows a positive evaluation tendency with respect to the attribute “vegetable” in packed lunch of any kind. Thus, the attribute “vegetable” corresponds to raising/lowering pattern 1 described above.

Likewise, the evaluation tendency classifier 106 identifies the raising/lowering patterns with respect to other attributes. In the example illustrated in FIG. 4, the attribute “fish” has raising/lowering pattern 4. Thus, a case where the individual positively evaluates the packed lunch having the attribute “fish” according to other attributes and a case where the individual negatively evaluates the packed lunch having the attribute “fish” according to other attributes are mixed. The evaluation tendency classifier 106 identifies such a mixed pattern.

The evaluation tendency classifier 106 outputs, as the evaluation tendency table 107, a determination result of the evaluation tendency raising/lowering patterns as illustrated in FIG. 4 and a determination result as to which attribute corresponds to the mixed pattern.

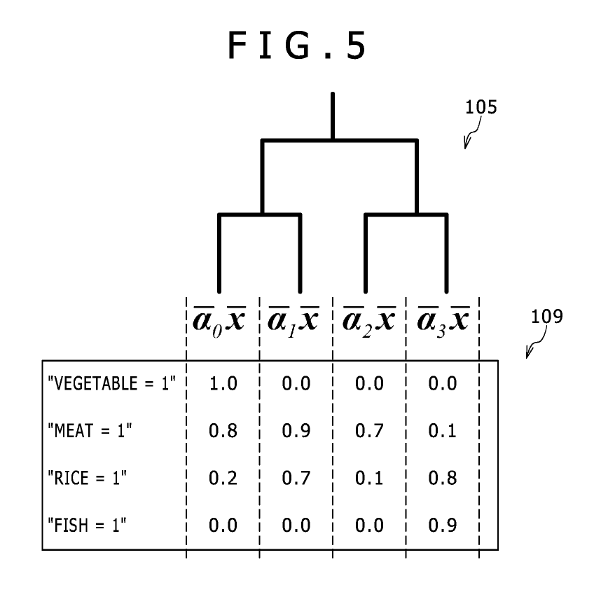

FIG. 5 is a concept view of assistance in explaining a process of the feature quantity analyzer 108. The feature quantity analyzer 108 analyzes a feature quantity of a group of products classified into each leaf node of the preference tree data 105 by the preference tree data 105. For example, when a tendency in which a product classified into evaluation function a0x has the attributes “vegetable” and “meat” is strong, it is considered that in a feature quantity vector of the group of products classified into the leaf node, values of “vegetable” and “meat” are relatively large. In the example illustrated in FIG. 5, a feature quantity vector of the group of products classified into evaluation function a0x (vegetable, meat, rice, fish)=(1.0, 0.8, 0.2, 0.0). Likewise, the feature quantity analyzer 108 calculates feature quantity vectors of other leaf nodes, and outputs them as the feature quantity data 109.

To calculate a feature quantity by the feature quantity analyzer 108, for example, the following method is considered. Other appropriate methods may be used.

### (Method 1 for Calculating a Feature Quantity Vector: Occupation Rate)

A rate between the number of products classified into a leaf node and the number of products classified into the same leaf node and having a particular attribute is used as a feature quantity of the attribute. For example, when the number of products classified into evaluation function a0x is 20, and the number of products classified into the same and having the attribute “vegetable” is 10, a feature quantity of the attribute “vegetable” of the leaf node is 10/20=0.5. Likewise, feature quantities of other attributes are calculated. The calculated values may be subjected to an appropriate process (e.g., normalization). This is ditto for a distribution rate below.

### (Method 2 for Calculating a Feature Quantity Vector: Distribution Rate)

A rate between the total number of products used for learning the preference tree data 105 and the number of products having a particular attribute in each node is used as a feature quantity of the attribute. For example, when the number of products used for learning the preference tree data 105 and having the “vegetable” is 100, and the number of products classified into evaluation function a0x and having the attribute “vegetable” is 30, a feature quantity of the attribute “vegetable” of the leaf node is 30/100=0.3. Likewise, feature quantities of other attributes are calculated.

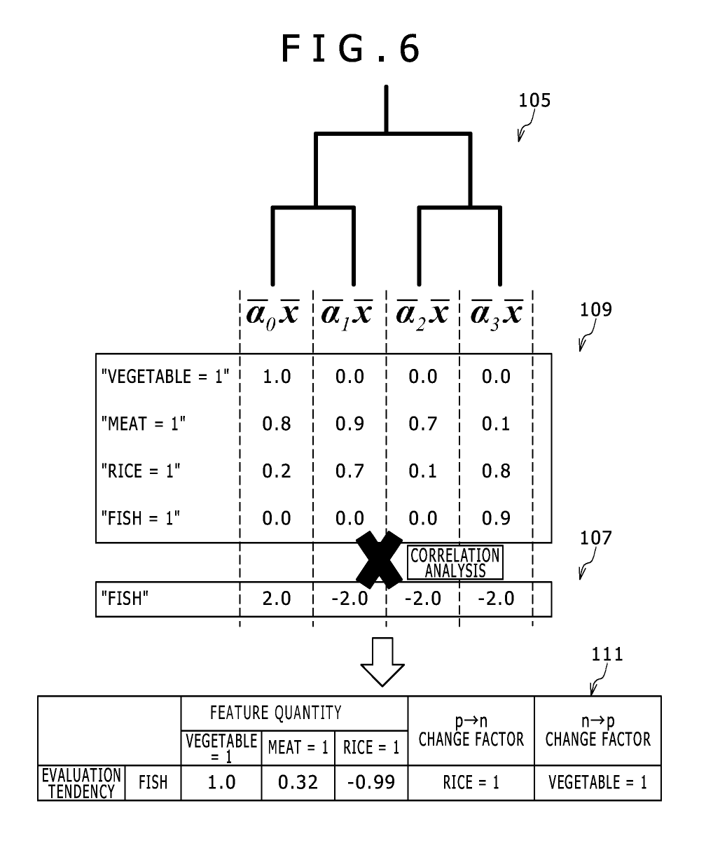

FIG. 6 is a concept view of assistance in explaining a process of the change factor extractor 110. The feature quantity data 109 represents feature quantities of a group of products classified into each evaluation function, and the evaluation tendency table 107 represents a tendency pattern in which each evaluation function contributes to evaluation of each attribute. By analyzing correlation between these, it is considered that an attribute having positive correlation and an attribute having negative correlation with respect to an evaluation tendency raising/lowering pattern can be identified. Thus, the change factor extractor 110 calculates correlation between the feature quantity data 109 and the evaluation tendency table 107. Here, to identify an attribute that influences evaluation of an attribute representing the mixed pattern, correlation with respect to the evaluation tendency pattern of the attribute “fish” is calculated.

For example, when an evaluation tendency pattern of the “fish” and a feature quantity vector of “vegetable=1” represent positive correlation, it can be estimated that the “vegetable” is a change factor that positively changes evaluation of the “fish”. Likewise, for example, when an evaluation tendency pattern of the “fish” and “rice” represent negative correlation, it can be estimated that the “rice” is a change factor that negatively changes evaluation of the “fish”. Based on a result of correlation analysis, the change factor extractor 110 identifies the positive change factor (an n→p change factor in FIG. 6) and the negative change factor (a p→n change factor in FIG. 6). For example, it is determined that an attribute in which a correlation coefficient is equal to or more than a positive threshold value is the positive change factor, and that an attribute in which a correlation coefficient is equal to or less than a negative threshold value is the negative change factor.

The change factor extractor 110 calculates a correlation coefficient between an evaluation tendency pattern of the attribute “fish” and other attributes, identifies the positive change factor and the negative change factor, and outputs them as the change factor table 111.

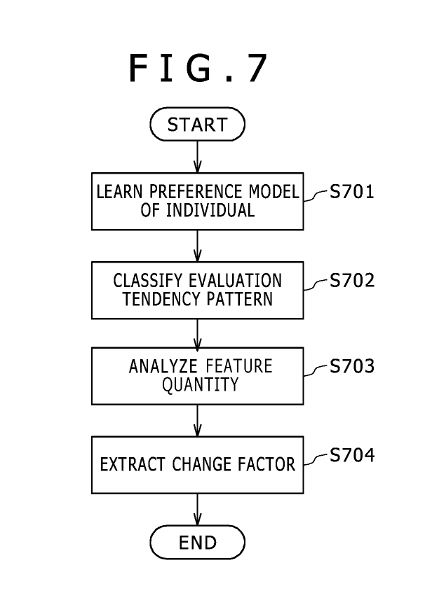

FIG. 7 illustrates an operation flow of the center server 100. For example, when the operator instructs the center server 100 to extract change factors of a product, the center server 100 starts this flowchart.

The preference learner 104 learns a preference model of an individual with respect to a designated product, and outputs it as the preference tree data 105 (S701). For example, preferences associated with a plurality of individuals, such as all women in thirties, may be united and learned as one preference model. Alternatively, a preference model associated with a particular individual may be learned. In addition, a plurality of preference models of a limited number of particular individuals may be constructed. For example, to ensure robustness, a plurality of preference models may be learned from the same learning data and the same product attribute data by using a random forest method.

In addition, a preference model associated with prepared food and a preference model associated with home appliance may be learned for each of different product categories. The preference model associated with prepared food and a preference model associated with all food including prepared food can also be learned separately. Even when evaluating a same product, different preference models may be learned by changing a viewpoint of an attribute given. For example, the preference model associated with prepared food may be separated into a preference model that performs evaluation only by an objectively determinable product attribute, such as ingredient and nutrient information, and a preference model that performs evaluation by habit mixed information, such as a target layer and a planning concept of each product set by the product planning person. An attribute vector in which objective information/habit information are mixed may be set as one preference model.

The analyzing person can set an attribute associated with purchase to be analyzed and a product in a range to be evaluated according to analyzing purpose, thereby learning preference. That is, the number of preference tree data 105 created is equal to the number of given preference models according to condition. For example, when one preference model is to be created for each individual, it is necessary to create the preference tree data 105 for each of the individual. For simplification of the description, hereinafter, purchase preference of a particular individual with respect to a particular product (e.g., packed lunch) is learned.

The evaluation tendency classifier 106 classifies an evaluation tendency pattern of the individual with respect to the product by the method described with reference to FIG. 4 (S702). The feature quantity analyzer 108 analyzes a feature quantity of the product by the method described with reference to FIG. 5 (S703). The change factor extractor 110 extracts change factors by the method described with reference to FIG. 6 (S704). The detail of steps S701 to S704 will be described later.

FIG. 8 is a flowchart of assistance in explaining the detail of step S701. Each step in FIG. 8 will be described below. The detail of this flowchart is also described in Japanese Patent Application No. 2013-170189.

(FIG. 8: step S801)

The preference learner 104 reads the POS data 101, the stock management data 102, and the product master 103. The preference learner 104 obtains an ID of each individual (consumer) described by the POS data 101 and the number of individuals N.

(FIG. 8: steps S802 and S803)

The preference learner 104 initializes number n of the consumer (S802). The preference learner 104 obtains a purchase history of consumer n from the POS data 101 (S803).

(FIG. 8: step S804)

The preference learner 104 obtains, from the POS data 101, an ID of a product purchased by consumer n, and obtains an attribute vector of the product from the product master 103.

(FIG. 8: steps S805 and S806)

The preference learner 104 learns a branch condition of a preference tree that can satisfactorily isolate purchase preference of consumer n (S805). The preference learner 104 calculates a matrix of coefficients, by which product attributes of each leaf node are multiplied, so that for example, a conditional selection probability of the product classified into the leaf node is maximum (S806). The preference learner 104 stores the result obtained in these steps in the preference tree data 105.

(FIG. 8: steps S807 and S808)

The preference learner 104 increments a value of n by 1 (S807). If there are any consumers which preference model has not been learned, the preference learner 104 returns to step S803 to execute the same process. If the preference learner 104 completes learning with respect to all consumers, it ends this flowchart (S808).

(FIG. 8: step S805: Supplement 1)

The preference learner 104 selects a branch condition of a preference tree of customer n. That is, the preference learner 104 decides the branch condition of the preference tree, characteristic/sign/level, and so on of the branch condition. For example, examples of branch condition candidates include “price<500 yen”, “calorie>1000 kcal”, and “salt content≦g”. In addition, the presence of fish is set to 1, and the absence of fish is set to 0, so that “fish=1” can be a branch condition candidate. For example, from among a plurality of branch condition candidates having a combination of the characteristic/sign/level, the candidate in which isolation ability of a purchase result is the highest is adopted. When dividing a product attribute vector included in a learning data set depending on whether the condition candidate is satisfied, the high isolation ability condition can simultaneously isolate the result of purchased or not purchased.

### (FIG. 8: Step S805: Supplement 2)

The preference learner 104 divides all products included in learning data, into a group of products satisfying a condition candidate and a group of products not satisfying the condition candidate, and calculates a rate of the number of purchased products in the group of products satisfying the condition and a rate of the number of purchased products in the group of products not satisfying the condition. Then, the rate of the number of purchased products in the group of products satisfying the condition is compared with the rate of the number of purchased products in the group of products not satisfying the condition. As a difference between the rates is increased, the isolation ability becomes higher. The comparison of the rates can be executed by using information entropy and the amount of kullback-liebler information. Other methods may be used to evaluate the isolation ability.

### (FIG. 8: Step S806: Supplement)

The preference learner 104 can set a coefficient matrix of each leaf node so that for example, from among a plurality of products to be selected, the product having the highest preference point is selected. For example, an equation of a conditional selection probability is created by using a logit model, and a coefficient matrix is then estimated so that the conditional selection probability associated with a selected product is maximum from past purchase history data. Other appropriate methods may also be used to set the coefficient matrix.

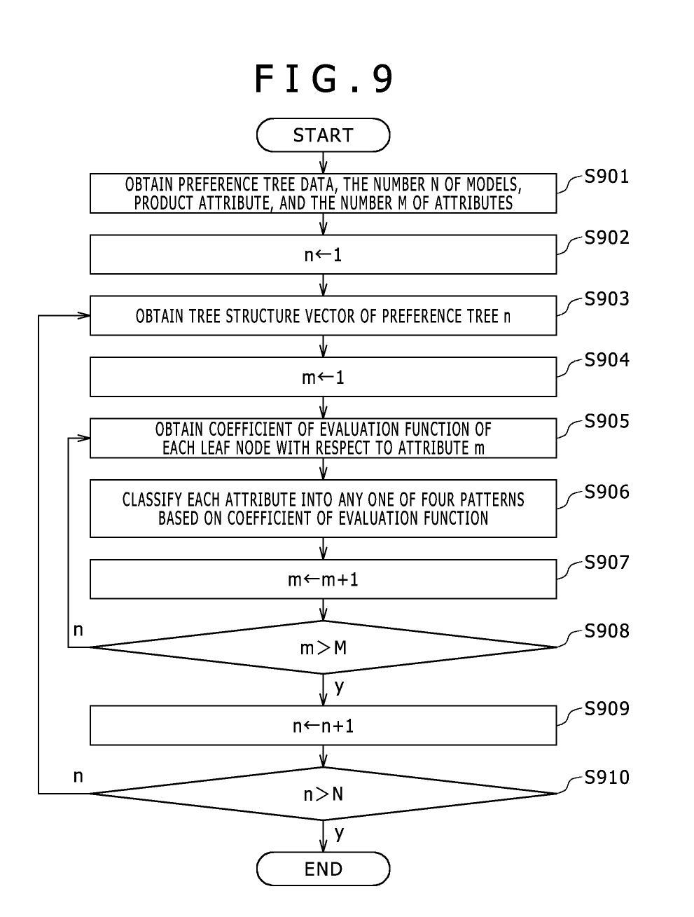

FIG. 9 is a flowchart of assistance in explaining the detail of step S702. Each step in FIG. 9 will be described below.

(FIG. 9: step S901)

The evaluation tendency classifier 106 reads the preference tree data 105, and obtains a preference model associated with a designated individual and a designated product and the number N of preference models. The evaluation tendency classifier 106 obtains an attribute of the product and the number of attributes M from the product master 103.

### (FIG. 9: Step S902)

The evaluation tendency classifier 106 initializes number n of a preference tree (corresponding to one preference model).

### (FIG. 9: Step S903)

The evaluation tendency classifier 106 obtains the preference tree data 105 associated with preference tree n. When each coefficient of an evaluation function is subjected to a correction process such as normalization, the evaluation tendency classifier 106 previously obtains a parameter such as a reference value associated with the correction process. The parameter is described in, e.g., the preference tree data 105.

### (FIG. 9: Steps S904 and S905)

The evaluation tendency classifier 106 initializes number in of the attribute (S904). The evaluation tendency classifier 106 obtains a coefficient of each evaluation function, by which attribute m is multiplied, according to the procedure described with reference to FIG. 4, and stores it in the evaluation tendency table 107 (S905). When the coefficient is subjected to normalization, the processed value is stored in the evaluation tendency table 107.

### (FIG. 9: Step S906)

In accordance with the method described in FIG. 4, the evaluation tendency classifier 106 classifies an evaluation tendency with respect to attribute m of the product into any one of the previously-described four raising/lowering patterns based on the coefficient of each evaluation function, and stores the result in the evaluation tendency table 107.

### (FIG. 9: Steps S907 and S908)

The evaluation tendency classifier 106 increments a value of m by 1 (S907). If there are any attributes which evaluation tendency pattern has not been classified, the evaluation tendency classifier 106 returns to step S905 to execute the same process, and if the evaluation tendency classifier 106 completes classification with respect to all attributes, it goes to step S909 (S908).

### (FIG. 9: Steps S909 and S910)

The evaluation tendency classifier 106 increments a value of n by 1 (S909). If there are any preference models in which an evaluation tendency pattern has not been classified, the evaluation tendency classifier 106 returns to step S903 to execute the same process, and if the evaluation tendency classifier 106 completes classification with respect to all preference models, it ends this flowchart (S910).

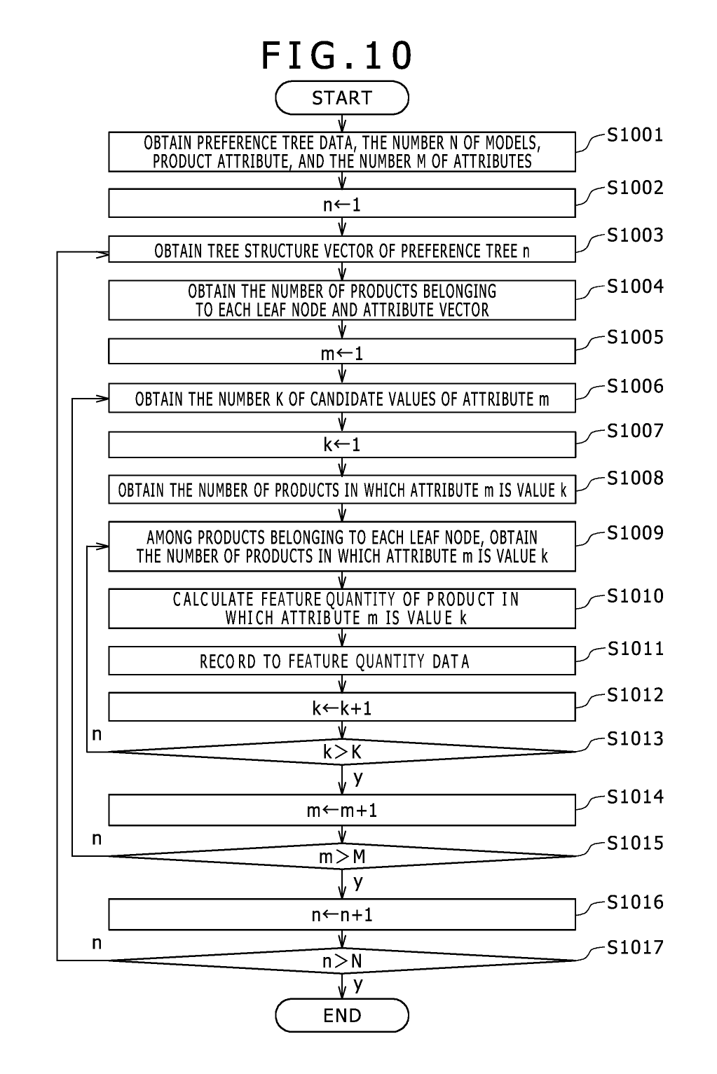

FIG. 10 is a flowchart of assistance in explaining the detail of step S703. Each step in FIG. 10 will be described below.

### (FIG. 10: Step S1001)

The feature quantity analyzer 108 reads the preference tree data 105, and obtains a preference model associated with a designated individual and a designated product, and obtains the number N of preference models. The feature quantity analyzer 108 obtains an attribute of the product and the number M of attributes from the product master 103. Here, the attribute used in the feature quantity analyzer 108 does not necessarily coincide with all attributes used in preference model learning. For example, when only a feature associated with a given attribute is to be noted, all attributes used in preference model learning are not required to be used for this analysis. In addition, attributes “chicken”, “pork”, and “beef” may be united into attribute “meat”, and may be replaced by attribute information of an upper layer when there is a hierarchy relationship between the attributes.

### (FIG. 10: Steps S1002 and S1003)

The feature quantity analyzer 108 initializes number n of the preference tree (S1002), and obtains the preference tree data 105 associated with preference tree n (S1003).

### (FIG. 10: Step S1004)

The feature quantity analyzer 108 classifies the product described by the POS data 101 according to a structure of preference tree n into each leaf node of preference tree n, and obtains the number of products classified into the leaf node and an attribute vector of each product. If a result obtained by classifying each product when the preference learner 104 learns the preference tree data 105 is stored, the result may be used without classifying each product.

### (FIG. 10: Step S1005)

The feature quantity analyzer 108 initializes number m of the attribute.

### (FIG. 10: Step S1006)

The feature quantity analyzer 108 obtains the number of candidates K of values by which attribute m can take. For example, an attribute represented according to whether each product has the attribute is any one of “0” and “1” as an attribute value, K=2. In the case of an attribute in which a plurality of candidate values are present, like a price range, K is the number of candidate values thereof. If a product attribute with values in succession is set in preference model learning, the number of candidates is decided by discretely dividing the values by a given range.

### (FIG. 10: Step S1007)

The feature quantity analyzer 108 initializes number k of an attribute candidate value.

### (FIG. 10: Steps S1008 and S1009)

The feature quantity analyzer 108 obtains, from among all products classified by preference tree n, the number of products in which a value of attribute m is candidate value k (S1008). The feature quantity analyzer 108 obtains, from among products classified into each leaf node, the number of products in which a value of attribute m is candidate value k (S1009).

### (FIG. 10: Steps S1010 and S1011)

According to the method described with reference to FIG. 5, the feature quantity analyzer 108 calculates a feature quantity of a product in which a value of attribute in is candidate value k (S1010). The feature quantity analyzer 108 stores the calculated feature quantity in the feature quantity data 109 (S1011).

### (FIG. 10: Steps S1012 and S1013)

The feature quantity analyzer 108 increments a value of k by 1 (S1012). If there are any attribute candidate values in which a feature quantity has not been calculated, the feature quantity analyzer 108 returns to step S1009 to execute the same process, and if the feature quantity analyzer 108 completes calculation with respect to all candidate values, it goes to step S1014 (S1013).

### (FIG. 10: Steps S1014 and S1015)

The feature quantity analyzer 108 increments a value of m by 1 (S1014). If there are any attributes in which a feature quantity has not been calculated, the feature quantity analyzer 108 returns to step S1006 to execute the same process, and if the feature quantity analyzer 108 completes calculation with respect to all attributes, it goes to step S1016 (S1015).

### (FIG. 10: Steps S1016 and S1017)

The feature quantity analyzer 108 increments a value of n by 1 (S1016). If there are any preference models in which a feature quantity has not been calculated, the feature quantity analyzer 108 returns to step S1003 to execute the same process, and if the feature quantity analyzer 108 completes calculation with respect to all preference models, it ends this flowchart (S1017).

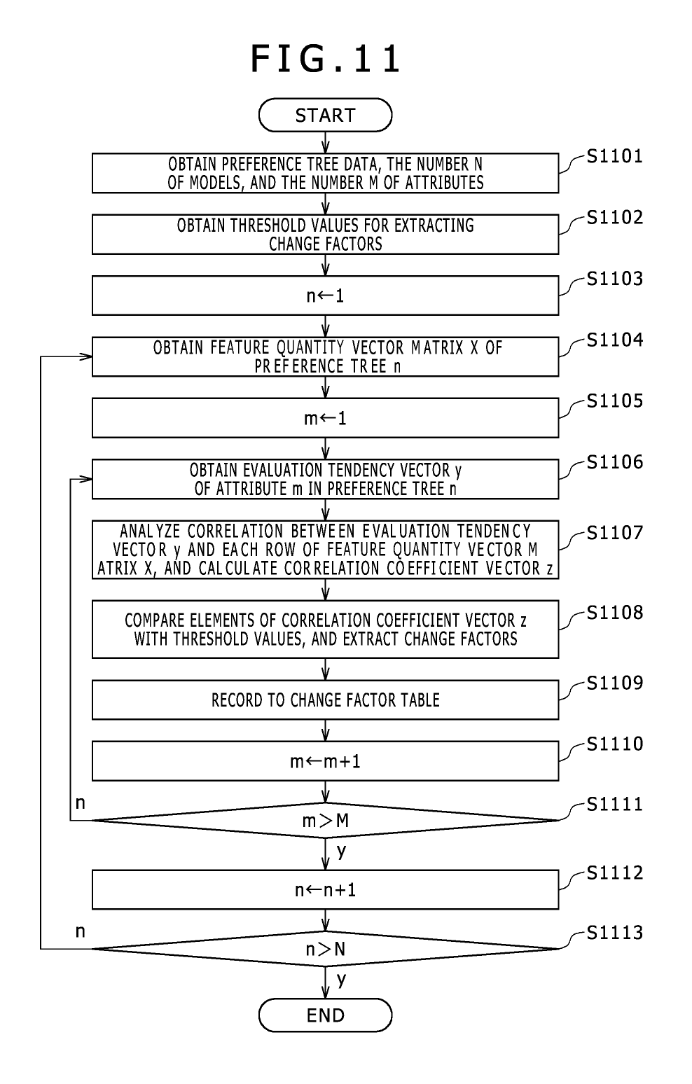

FIG. 11 is a flowchart of assistance in explaining the detail of step S704. Each step in FIG. 11 will be described below.

### (FIG. 11: Step S1101)

The change factor extractor 110 reads the preference tree data 105, and obtains a preference model associated with a designated person and a designated product, and obtains the number N of preference models. The change factor extractor 110 obtains the number M of attributes of the product from the product master 103.

### (FIG. 11: Step S1102)

The change factor extractor 110 obtains threshold values used for extracting change factors. The threshold values here are threshold values for determining whether a correlation coefficient calculated by the procedure described with reference to FIG. 6 is a positive change factor or a negative change factor. These threshold values are previously stored in an appropriate storage unit, such as the change factor table 111 before an extraction result is stored.

### (FIG. 11: Steps S1103 and S1104)

The change factor extractor 110 initializes number n of a preference tree (S1103). The change factor extractor 110 obtains the feature quantity data 109 associated with preference tree n (S1104). As illustrated in FIGS. 5 and 6, the feature quantity data 109 is a feature quantity vector matrix.

### (FIG. 11: Step S1105)

The change factor extractor 110 initializes number m of an attribute.

### (FIG. 11: Step S1106)

The change factor extractor 110 obtains an evaluation tendency vector of attribute in in preference tree n. The evaluation tendency vector here has coefficients that represent an evaluation tendency raising/lowering pattern with respect to each attribute described with reference to FIG. 4. For example, in FIG. 4, the evaluation tendency vector is a vector (2.0, −2.0, −2.0, −2.0) obtained by taking out coefficients of each evaluation function, by which the attribute “fish” is multiplied. Since the following steps are executed only to the mixed pattern, only an evaluation tendency vector of the mixed pattern may be obtained in this step. Thus, the following step with respect to attribute in that does not have the mixed pattern may be omitted, or may be executed without being omitted.

### (FIG. 11: Step S1107)

The change factor extractor 110 calculates a correlation coefficient between the evaluation tendency vector and each row of the feature quantity vector matrix. For example, in FIG. 6, a correlation coefficient between the evaluation tendency vector (107) of the attribute “fish” and the first row of the feature quantity vector matrix (109) is calculated to calculate correlation between the attributes “fish” and “vegetable”. Likewise, the change factor extractor 110 calculates correlation coefficients between the evaluation tendency vector (107) of the attribute “fish” and the 2nd to 4th rows of the feature quantity vector matrix (109). The calculated correlation coefficients become the correlation coefficient vector as illustrated at the lower side of FIG. 6. The change factor extractor 110 stores this in the change factor table 111.

### (FIG. 11: Steps S1108 and S1109)

The change factor extractor 110 compares each element value of the correlation coefficient vector with the threshold values obtained in step S1102, and extracts the positive change factor or the negative change factor with respect to attribute m (S1108). The change factor extractor 110 stores the result obtained by identifying the change factors in the change factor table 111 (S1109).

### (FIG. 11: Steps S1110 and S1111)

The change factor extractor 110 increments a value of m by 1 (S1110). If there are any attributes change factors have not been extracted, the change factor extractor 110 returns to step S1106 to execute the same process, and if the change factor extractor 110 completes extraction with respect to all attributes, it goes to step S1112 (S1111).

### (FIG. 11: Steps S1112 and S1113)

The change factor extractor 110 increments a value n by 1 (S1112). If there are any preference models in which the change factors have not been extracted, the change factor extractor 110 returns to step S1104 to execute the same process, and if the change factor extractor 110 completes extraction with respect to all preference models, it ends this flowchart (S1113).

### First Embodiment

### Summary

As described above, the preference analyzing system 1000 according to the first embodiment learns purchase preference of an individual based on purchase history data (the POS data 101), identifies an attribute representing the mixed pattern, and calculates correlation between the attribute representing the mixed pattern and a product feature quantity. This can estimate change factors with respect to a product having the attribute representing the mixed pattern. This estimation is based on a purchase history described by the POS data 101. That is, the change factors can be extracted based on a learning result of the purchase preference.

In this example, only “like or dislike according to condition” has the mixed pattern. However, for example, another pattern “basically like, but like more according to condition” may be analyzed. Also in this case, a change factor (p→p+change factor) that changes “like” to “like more” can be extracted by the change factor extractor.

### Second Embodiment

In a second embodiment of the present invention, a specific example in which the analyzing result by the center server 100 described in the first embodiment is used in the store server 200. The center server 100 analyzes an evaluation tendency pattern of each consumer and change factors with respect to a product attribute. The store server 200 totalizes these with respect to each consumer who visits a store, and can make use of its totalizing result for improving business of the store.

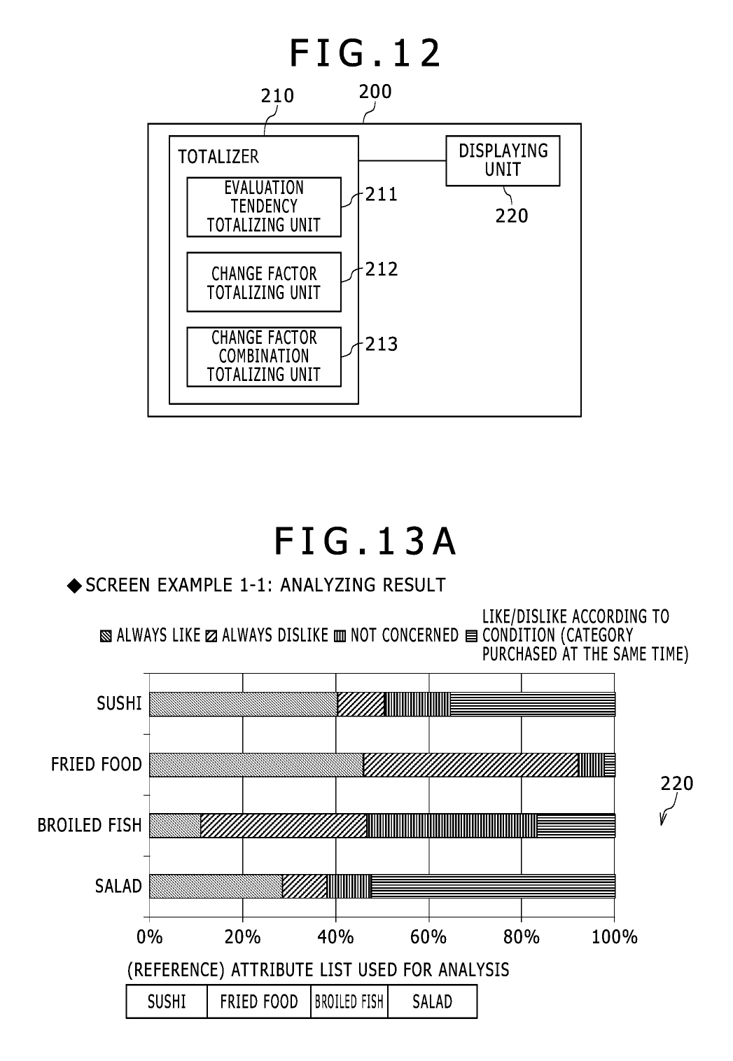

FIG. 12 is a function block diagram of the store server 200 according to the second embodiment. The store server 200 includes a totalizer 210 and a displaying unit 220. The totalizer 210 includes an evaluation tendency totalizing unit 211, a change factor totalizing unit 212, and a change factor combination totalizing unit 213. The detail of these functioning units will be described later. The displaying unit 220 includes a display device such as a display, and displays a totalizing result by the totalizer 210 on the screen. Other configuration is the same as the first embodiment.

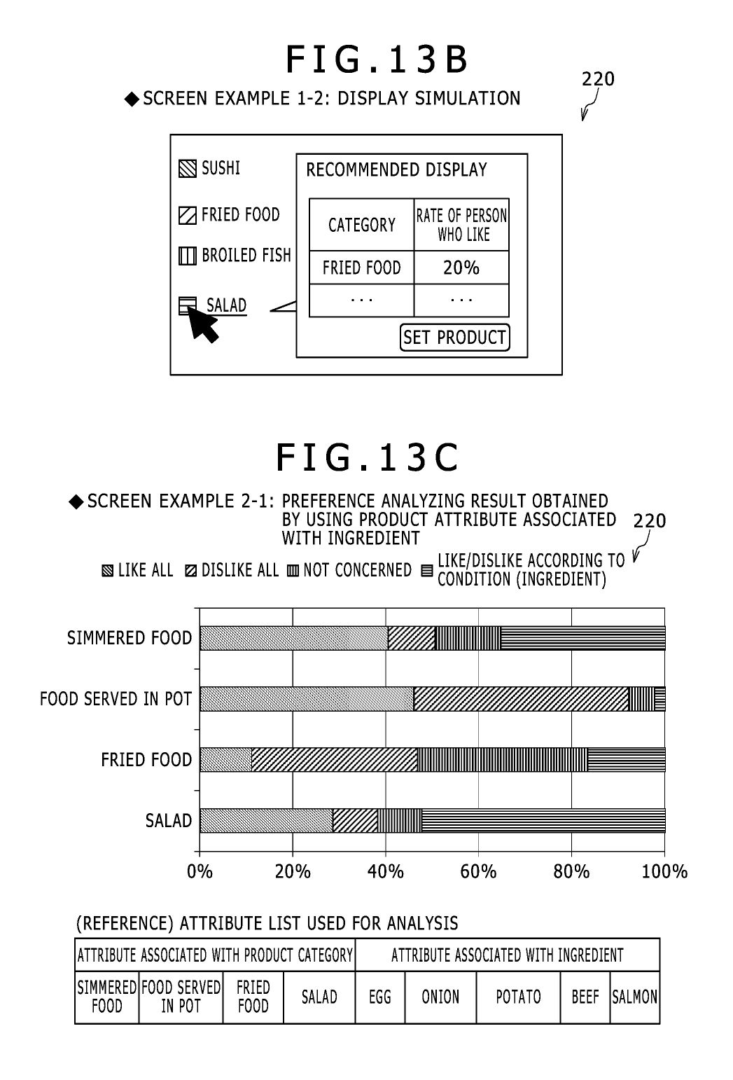

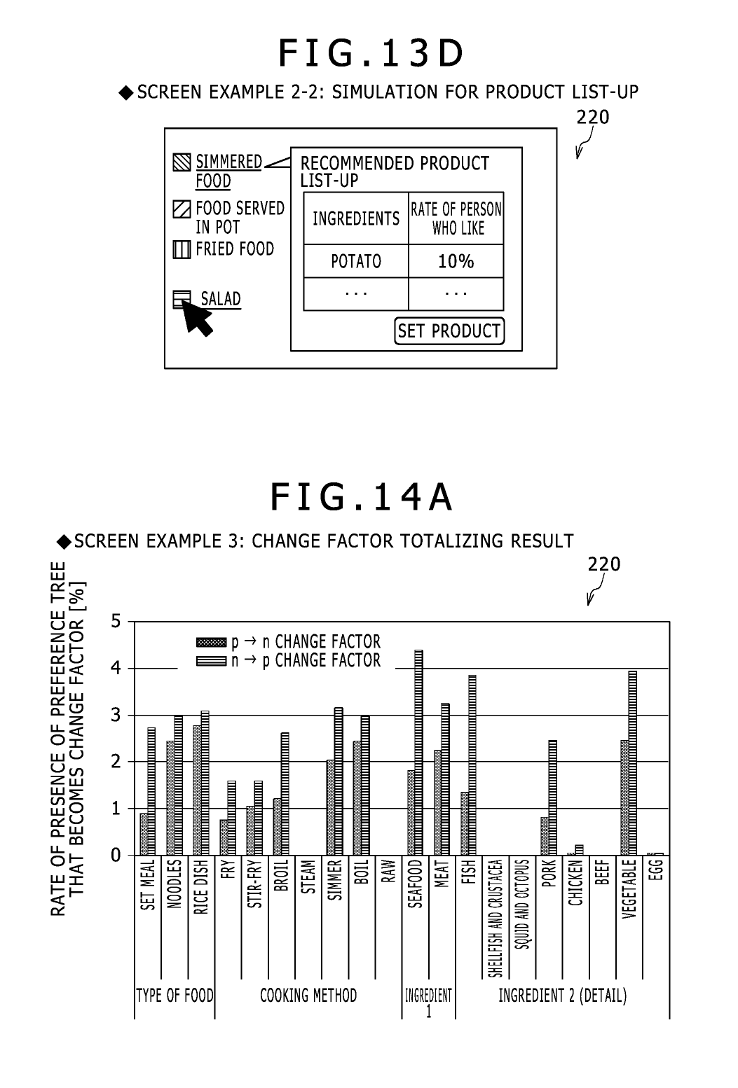

FIG. 13A illustrates a totalizing result example of the totalizer 210 and its screen display example. The evaluation tendency totalizing unit 211 obtains the evaluation tendency table 107 created by the center server 100 and associated with each customer in the store, and totalizes and analyzes evaluation tendencies of all customers. In the example illustrated in FIG. 13A, assume that the center server 100 executes analysis by using, as a product attribute, a product category sold by the store. Specifically, the center server 100 represents, by binary values of I/O, whether there is a product category in a basket of each customer in the store (a group of products purchased at the same time at checkout counter 1), and compares combinations of the product category and other product categories to be taken, thereby learning a preference model of the customer. Evaluation tendencies of all customers with respect to the product category are totalized so that it is possible to analyze which product category the customers in the store tend to like.

In the example illustrated in FIG. 13A, “always like” means a rate of the number of customers who always like a product category regardless of combinations of the product category and other product categories. A product category “fried food” has a higher rate of “always like” than “broiled fish”; it can be understood that the product category “fried food” is very popular. From this, its selling space in the store can be widened. In addition, since many customers show the mixed pattern with respect to a product category “salad”, it is considered that the volume of sales thereof can be increased according to a product category combined with “salad” for selling. This point is ditto for “sushi”. The above result can be useful for studying a displaying place and selling different kinds of products together.

FIG. 13B illustrates another example of a totalizing result by the totalizer 210 associated with the same analyzing result as FIG. 13A and its screen display. The change factor totalizing unit 212 obtains the change factor table 111 created by the center server 100 and associated with each customer in the store, and totalizes and analyzes change factors associated with all customers.

The evaluation tendency totalizing unit 211 highlights the product categories corresponding to the mixed pattern in FIG. 13A on the screen in FIG. 13B. When the operator selects any one of the highlighted product categories, the change factor totalizing unit 212 displays a totalizing result associated with a positive change factor of the product category on the screen. The example illustrated in FIG. 13B shows that a rate between the number of customers in which the positive change factor with respect to “salad” is “fried food” and the number of all customers in the store is 20%.

FIG. 13C is a display example of another preference model learning result. In FIGS. 13A and 13B, a product attribute is only a product category, and an analyzing result of influence by combinations of a plurality of product categories is displayed, while in FIG. 13C, a preference model is learned by using, as product attributes, a product category and an ingredient of a product, and a result is displayer which is obtained by analyzing whether evaluation of product category is raised or lowered depending on difference in ingredients. That is, in the analyzing result displayed in FIG. 13C, “like all” means a customer who does not depend on ingredient, and likes all products in a product category, and “like/dislike according to condition (ingredient)” means a customer who does not always like all products in a product category, but likes them according to ingredient. In the case of FIG. 13C, there are many mixed patterns of “like/dislike according to condition (ingredient)” with respect to salad and simmered food. Thus, it is considered that the volume of sales can be increased by studying product line-up so as to display products along preference of each customer.

FIG. 13D illustrates another example of a totalizing result by the totalizer 210 associated with the same analyzing result as FIG. 13C and its screen display. Positive change factor extraction results associated with an ingredient that changes evaluation of each product category to “like” are totalized. This can be useful for studying product line-up as to what type of ingredient is included in a product to be stocked.

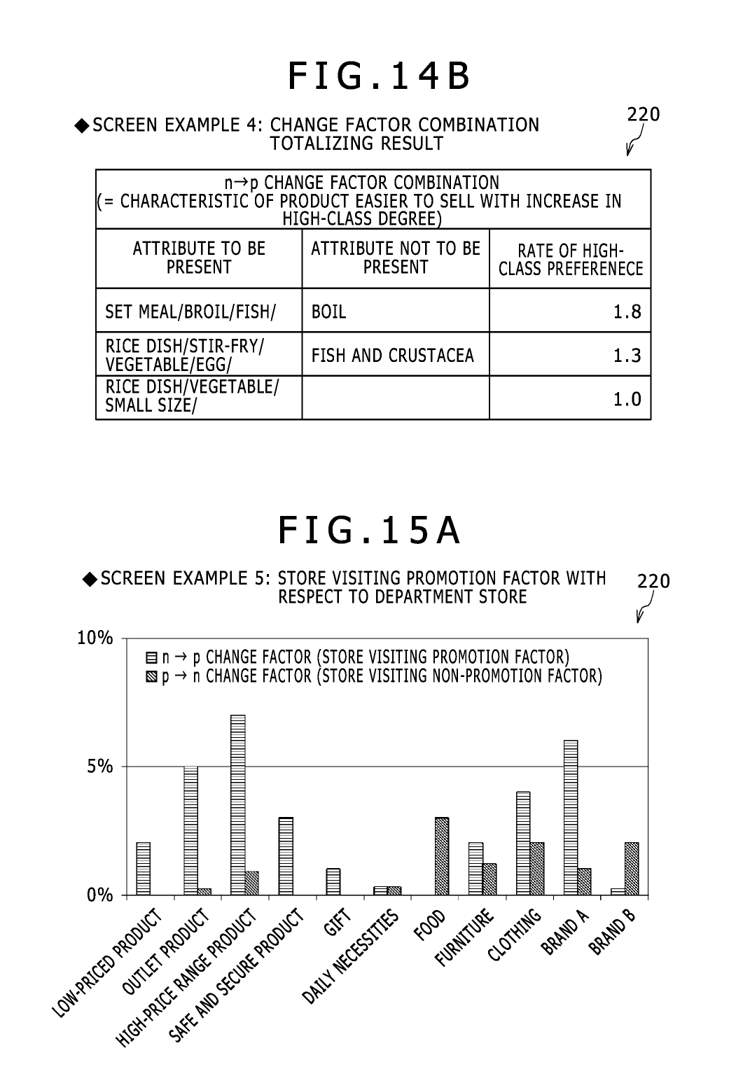

FIG. 14A illustrates another example of a totalizing result by the totalizer 210 and its screen display. Here, an attribute representing the mixed pattern is “price”, and a result is shown which is obtained in such a manner that the change factor totalizing unit 212 totalizes other attributes that become a positive change factor or a negative change factor with respect to “price” for all customers in the store.

The negative change factor with respect to “price” can be regarded as a product attribute to allow each customer to change from high-class preference to low-price preference. The positive change factor with respect to “price” can be regarded as a product attribute to allow each customer to change from low-price preference to high-class preference. Thus, both of the change factors are totalizably grasped so that the factors that totally change purchase preference of each customer can be grasped.

FIG. 14B illustrates another example of a totalizing result by the totalizer 210 and its screen display. Like the change factor totalizing unit 212, the change factor combination totalizing unit 213 totalizes change factors with respect to “price” for all customers in the store. When each change factor with respect to “price” is established by a combination of a plurality of attributes, the change factor combination totalizing unit 213 outputs the change factor with the combination.

For example, when there is a plurality of correlation coefficients that are equal to or more than the positive threshold value described with reference to FIG. 6, a combination of the correlation coefficients can be outputted as the positive change factor. Likewise, when there are a plurality of correlation coefficients that are equal to or less than the negative threshold value, a combination of the correlation coefficients can be outputted as the negative change factor. Further, the change factor combination totalizing unit 213 can also output a rate between the number of customers showing the combination change factor and the number of all customers (regarded as a rate of high-class preference persons).

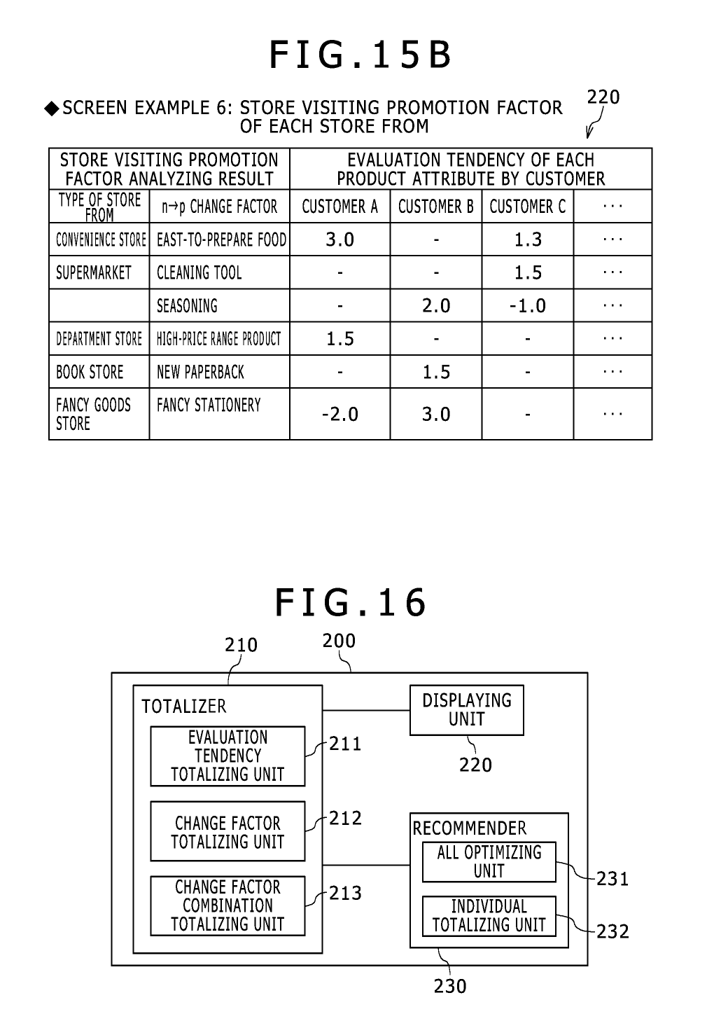

FIG. 15A illustrates another example of a totalizing result by the totalizer 210 and its screen display. When the POS data 101 describes in which store form a plurality of individuals purchase a product, the center server 100 analyzes this to extract a positive change factor that increases a store visiting frequency with respect to each store form.

In this example, an attribute representing the mixed pattern is “the presence or absence of store visiting”, and the change factor totalizing unit 212 totalizes other attributes that are a positive change factor and a negative change factor with respect to “the presence or absence of store visiting” for all customers in the store. Examples of the attribute that can be the change factors include a product category, a price, and a product promotion concept. This can analyze which product becomes a store vising promotion factor or a store visiting inhibition factor with respect to, e.g., a store form “department store”.

For example, when the department store and other store forms are compared, a positive change factor with respect to the department store can be regarded as an attribute in which a product having the attribute is liked only in the department store (the possibility of store visiting promotion is high). When the department store and other store forms are compared, a negative change factor with respect to the department store can be regarded as an attribute in which a product having the attribute is disliked only in the department store (the possibility of store visiting non-promotion is high).

FIG. 15B illustrates another example of a totalizing result by the totalizer 210 and its screen display. The store visiting change factors in FIG. 15A can be obtained as a totalizing result associated with a plurality of customers, and like the first embodiment, store visiting change factors associated with each individual associated with each store form can be obtained. The former can be used in a selling promotion activity in the entire store form. The latter can be used in a selling promotion activity for each customer.

### Second Embodiment

### Summary

As described above, the preference analyzing system 1000 according to the second embodiment totalizes analyzing results by the center server 100 for each store, and can statistically analyze purchase preference of each customer in the store. This can assist a marketing activity in the store.

### Third Embodiment

In the second embodiment of the present invention, as a specific example in which the analyzing result by the center server 100 described in the first embodiment is used in the store server 200, an example different from the second embodiment will be described.

FIG. 16 is a function block diagram of the store server 200 according to the third embodiment. The store server 200 includes a recommender 230, in addition to the configuration described in the second embodiment. The recommender 230 includes an overall optimizing unit 231 and an individual totalizing unit 232. The detail of the overall optimizing unit 231 and the individual totalizing unit 232 will be described later. Other configuration is the same as the second embodiment.

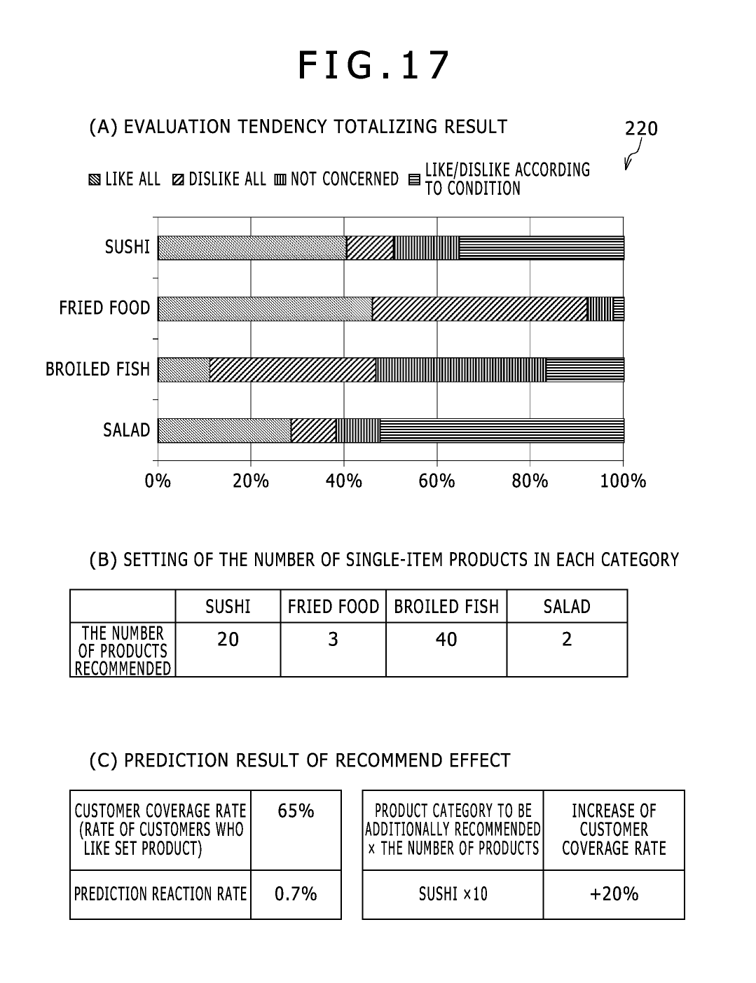

FIG. 17 are processing result examples of the overall optimizing unit 231 of the recommender 230 and their screen display examples. As described in FIG. 13A, the evaluation tendency totalizing unit 211 totalizes evaluation tendencies of customers with respect to a product attribute, and can output the totalizing result illustrated in FIG. 17(A). The overall optimizing unit 231 uses the totalizing result to analyze a product purchased by more customers, and shows this as a recommended product.

The overall optimizing unit 231 can identify a positive change factor and a negative change factor of each product category based on the totalizing result of the evaluation tendency totalizing unit 211 and the totalizing result of the change factor totalizing unit 212. The overall optimizing unit 231 calculates the number of product categories that can most positively change the total of evaluation tendencies of all customers. For example, when “salad” can be positively changed by “fried food”, it can be predicted that when the number of “fried food” is increased, the number of “salad” sold can be increased. However, the positive change factor for a product category can be the negative change factor for another product category. Thus, the overall optimizing unit 231 is required to calculate an optimum combination of products. As a specific method, a known optimizing method is used, as needed.

FIG. 17(B) illustrates a screen that displays the number of product categories recommended by the overall optimizing unit 231. FIG. 17(C) illustrates a screen that displays a result obtained by predicting expectation of the degree of a selling improvement effect in the store based on the recommendation. For example, a rate between the number of customers showing positive evaluation with respect to at least any one of product categories and the number of all customers can be shown as a customer coverage rate.

The operator can also adjust and input the number of product categories by observing the results in FIGS. 17(B) and (C). The overall optimizing unit 231 predicts, by the same method, the degree of the selling improvement effect to be expected on assuming the number of product categories after adjustment, and displays it on the screen.

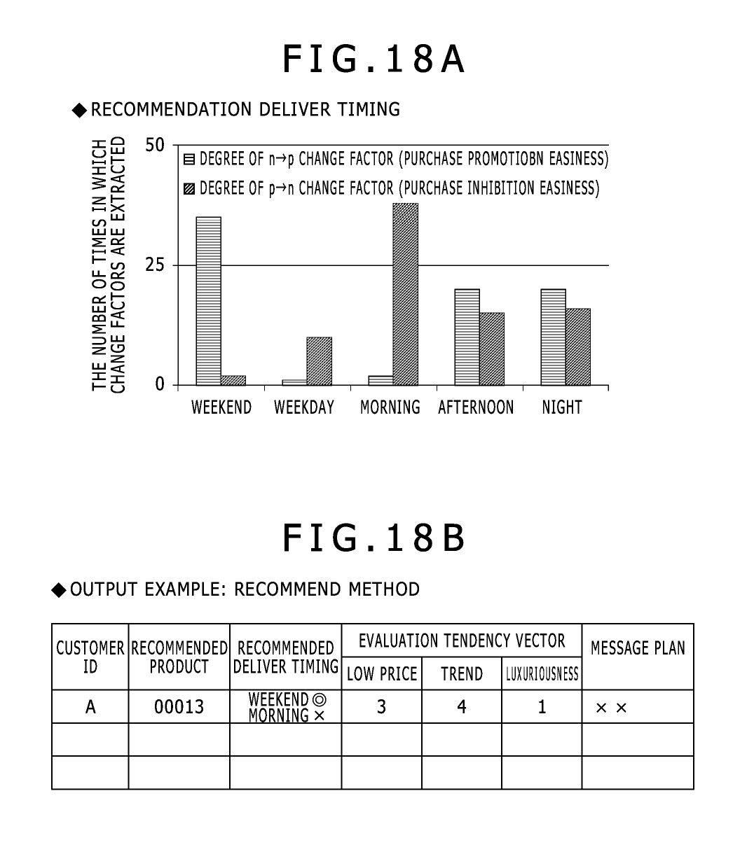

FIG. 18A is another example of a processing result by the individual totalizing unit 232 of the recommender 230 and its screen display. When a selling promotion message is transmitted to each customer by e-mail, the type of message to be transmitted and its transmission timing are important for marketing. Thus, the individual totalizing unit 232 assists decision-making when the selling promotion message is individually transmitted by using the analyzing result by the center server 100.

It is considered that the selling promotion message is desirably transmitted to a customer immediately before the customer purchases a product. Thus, the center server 100 learns and analyzes a preference model including, in a product attribute, information on a time period, such as “purchase time period” or “a day of the week (holiday/weekday) at purchase”, in addition to information on “product category”, and the individual totalizing unit 232 totalizes the number of times in which time period information in a preference model of an individual is extracted as an n→p change factor or a p→n change factor. The individual totalizing unit 232 decides, from the totalizing result, a time period and a day of the week to transmit the selling promotion message to each customer and a product category to be recommended.

FIG. 18B is a diagram illustrating a structure of a data table that holds an analyzing result by the individual totalizing unit 232 and a data example. The individual totalizing unit 232 can also obtain, from the center server 100, the evaluation tendency pattern described in the first embodiment to which an attribute other than the attributes “purchase time period” and “a day of the week at purchase” of each product corresponds (that is, the evaluation tendency table 107), and use this to decide the selling promotion message. For example, it is considered that the selling promotion message that promotes purchase of a product having an attribute corresponding to pattern 1 is desirable. It is considered that a product having an attribute corresponding to pattern 4 is desirably recommended together with a product having an attribute that positively changes this.

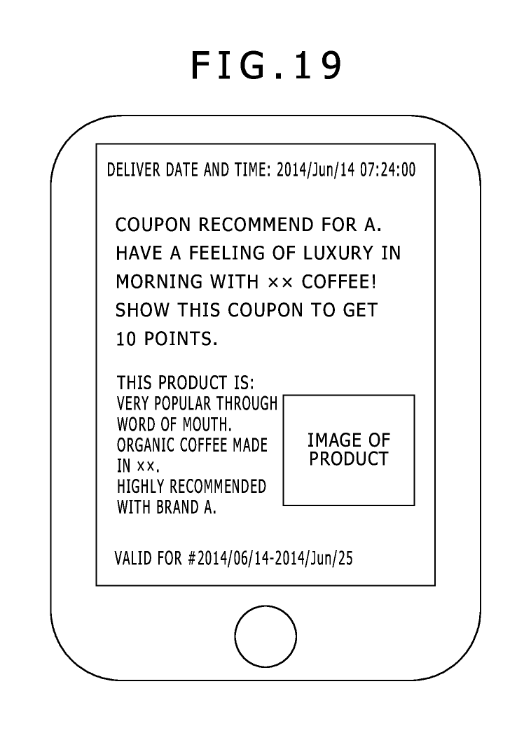

FIG. 19 is an example of the selling promotion message transmitted by the individual totalizing unit 232. The individual totalizing unit 232 decides the selling promotion message according to the data table described with reference to FIG. 18B, and transmits, e.g., the selling promotion message to each customer by e-mail. A timing at which the selling promotion message is transmitted is set according to the reference described with reference to FIG. 18A. The contents of the selling promotion message desirably promote purchase of a product in which the possibility that it is purchased in a time period and on a day of the week to transmit the message is high. When an attribute that becomes a positive change factor with respect to a product has been identified, the product having the attribute is recommended more desirably.

### Third Embodiment

### Summary

As described above, the preference analyzing system 1000 according to the third embodiment totalizes analyzing results by the center server 100 for each store, and uses them to assist a selling promotion activity in the store.

The present invention is not limited to the above embodiments, and includes various modifications. The above embodiments have been described in detail to easily understand the present invention, and are not necessarily limited to have all the described configurations. En addition, part of the configuration of one of the embodiments can be replaced by the configuration of the other embodiments. Further, the configuration of one of the embodiments can be added with the configuration of the other embodiments. Furthermore, part of the configuration of each embodiment can be added with, deleted from, and replaced by other configuration.

For example, in the first to third embodiments, the center server 100 and the store server 200 are implemented as different computers, but these functions can be put together into one server. In addition, the place to install each server is not limited, and for example, the store server 200 can be installed in an office that puts together central administrative tasks of administrative headquarters, not in a store. The store server 200 can be exploited, not only for a marketing task in a store, but also for a central marketing task. For example, the store server 200 can be exploited for unison measures with respect to a plurality of chain stores, Customer Relationship Management in retail headquarters, and product planning. Further, in the second and third embodiments, the displaying unit 220 displays the totalizing result by the totalizer 210 on the screen, but the output method is not limited to this, and for example, equal data can be outputted to a storage unit and to a communication line. An output unit that executes the output process is provided according to its output form, as needed.

Some or all of each of the above configurations, functions, processing units, and processing means may be achieved by hardware by designing by, e.g., an integrated circuit. In addition, each of the above configurations and functions may be achieved by software in such a manner that the processor interprets and executes a program that achieves each function. Information in a program, table, and file that achieve each function can be stored in a recording device such as a memory, a hard disk, and an SSD (Solid State Drive), and a recording medium, such as an IC card, an SD card, and a DVD.

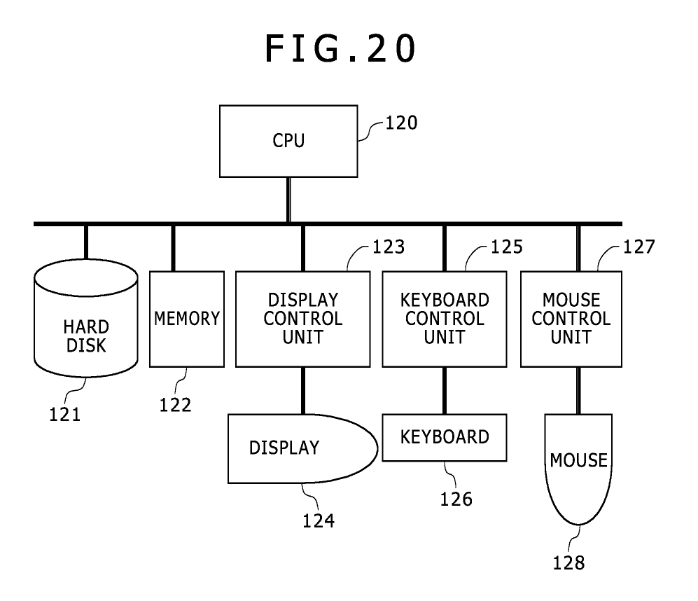

FIG. 20 is a hardware configuration example of the center server 100. Here, illustrated is a configuration example in which each functioning unit is implemented as software. The center server 100 includes a CPU (Central Processing Unit) 120, a hard disk 121, a memory 122, a display control unit 123, a display 124, a keyboard control unit 125, a keyboard 126, a mouse control unit 127, and a mouse 128. This configuration can be used in any of the first to third embodiments.

The CPU 120 executes each program stored in the hard disk 121. The hard disk 121 stores a program that implements functions of the functioning units of the center server 100 (the preference learner 104, the evaluation tendency classifier 106, the feature quantity analyzer 108, and the change factor extractor 110). The hard disk 121 further stores other data (the POS data 101, the stock management data 102, the product master 103, the preference tree data 105, the evaluation tendency table 107, the feature quantity data 109, and the change factor table 111).

The memory 122 stores data temporarily used by the CPU 120. The display 124, the keyboard 126, and the mouse 128 provide a screen interface, and an operation interface. The display control unit 123, the keyboard control unit 125, and the mouse control unit 127 are drivers of these devices.

The store server 200 can include the same hardware configuration as the center server 100. A hard disk of the store server 200 stores a program that implements functions of the totalizer 210 and the recommender 230, and the CPU executes this.

### REFERENCE SIGNS LIST

100: center server, 101: POS data, 102: stock management data, 103: product master, 104: preference learner, 105: preference tree data, 106: evaluation tendency classifier, 107: evaluation tendency table, 108: feature quantity analyzer, 109: feature quantity data, 110: change factor extractor, 111: change factor table, 200: store server, 210: totalizer, 220: displaying unit, 230: recommender, 1000: preference analyzing system.

1. A preference analyzing system that analyzes purchase preference of an individual, comprising:
a learner that learns purchase preference of the individual with respect to a product based on purchase history data that describes a history of the product purchased by the individual, and that stores tree structure data representing a learning result in a storage unit;
a classifier that extracts, from the learning result by the learner, a tendency in which evaluation by the individual with respect to the product is raised and lowered according to an attribute of the product, that classifies the extracted tendency based on a raising/lowering pattern thereof and that identifies, from among the classified raising/lowering patterns, a mixed pattern in which the pattern raising evaluation by the individual with respect to the product and the pattern lowering evaluation by the individual with respect to the product are mixed;
a feature quantity analyzer that extracts, as a vector of the attribute, a feature quantity of the product corresponding to each leaf node of the tree structure data; and
a change factor extractor that calculates correlation between the mixed pattern and the vector corresponding to each of the leaf nodes, thereby identifying, as a change factor, the attribute that raises or lowers evaluation by the individual with respect to the product having the attribute generating the mixed pattern, and that outputs a result thereof.

2. The preference analyzing system according to claim 1,
wherein the learner learns coefficients of a plurality of evaluation functions that evaluate the purchase preference, and learns a structure of the tree structure data so that the purchase history data is evaluated by the evaluation function that is optimum for evaluating the purchase history data.

3. The preference analyzing system according to claim 2,
wherein the evaluation function is a function that totals, for each of the attributes, numerical values obtained by multiplying numerical values representing the attribute by the coefficients,
wherein the tree structure data classifies a purchase history of the product described by the purchase history data into any one of the leaf nodes, and evaluates the purchase history classified into the leaf node by the evaluation function associated with the leaf node, and
wherein the classifier obtains, for each of the leaf nodes, the coefficient of the leaf node by which the same attribute is multiplied, and when the coefficient increasing an evaluation value and the coefficient decreasing an evaluation value are mixed in each of the obtained coefficients, the classifier determines that the attribute is the attribute that generates the mixed pattern.

4. The preference analyzing system according to claim 2,
wherein the feature quantity analyzer uses, as an element value of the vector corresponding to each of the leaf nodes, a rate between the number of purchase histories of the product classified into the leaf node by the tree structure data and the number of the purchase histories classified into the leaf node and having the attribute.

5. The preference analyzing system according to claim 2,
wherein the feature quantity analyzer uses, as an element value of the vector corresponding to each of the leaf nodes, orate between the total number of purchase histories of the product classified by the tree structure data and the number of the purchase histories classified into each of the leaf nodes by the tree structure data and having the attribute.

6. The preference analyzing system according to claim 1,
wherein the purchase history data describes the histories associated with a plurality of the individuals,
wherein the preference analyzing system includes a totalizer that totalizes processing results by at least any one of the learner, the classifier, the feature quantity analyzer, and the change factor extractor for the plurality of the individuals, and
wherein the preference analyzing system outputs a totalizing result by the totalizer.

7. The preference analyzing system according to claim 6,
wherein the totalizer totalizes classification results of the tendencies by the classifier for the plurality of the individuals, and outputs the totalizing result.

8. The preference analyzing system according to claim 7,
wherein the totalizer totalizes identification results of the change factors by the change factor extractor for the plurality of the individuals, and
wherein the preference analyzing system outputs a result obtained in such a manner that the totalizer totalizes identification results by the change factor extractor for the plurality of the individuals, as the change factors that raise and lower evaluation by the plurality of the individuals with respect to the product.

9. The preference analyzing system according to claim 8,
wherein the preference analyzing system uses, as the attribute, a price of the product, and
wherein the preference analyzing system outputs the change factors that raise and lower evaluation by the plurality of the individuals with respect to the price of the product based on a totalizing result by the totalizer.

10. The preference analyzing system according to claim 9,
wherein when evaluation by the plurality of the individuals with respect to the price of the product is raised and lowered according to a combination of the plurality of the change factors, the preference analyzing system outputs the combination.

11. The preference analyzing system according to claim 8,
wherein the preference analyzing system uses, as the attribute, a store form in which the individual purchases the product, and
wherein the preference analyzing system outputs the change factors that increase and decrease purchase frequencies of the plurality of the individuals in each of the store forms based on a totalizing result by the totalizer.

12. The preference analyzing system according to claim 8,
wherein the preference analyzing system statistically estimates an amount in which evaluation by the plurality of the individuals with respect to the product is raised and lowered by adjusting the change factors based on a result obtained in such a manner that the totalizer totalizes classification results by the classifier, and outputs the estimation result.

13. The preference analyzing system according to claim 8,
wherein the preference analyzing system uses, as the attribute, at least any one of a time period and a day of the week at purchasing the product by the individual, and
wherein the preference analyzing system determines whether each of the time periods or each of the days of the week corresponds to the change factors that increase and decrease a purchase frequency of the individual, and outputs the result.

14. The preference analyzing system according to claim 13,
wherein the preference analyzing system transmits a message that promotes purchase of the product with respect to the individual in the time period or the day of the week extracted as the change factor that increases the purchase frequency of the individual.
